(19) United States
(12) Patent Application Publication
(10) Pub. No.: US 2017/0003532 A1
(43) Pub. Date: Jan. 5, 2017

(54) OPTICAL DEVICE

(71) Applicant: CITIZEN HOLDINGS CO., LTD., Tokyo (JP)

(72) Inventor: Shinya KONDOH, Tokyo (JP)

(73) Assignee: CITIZEN HOLDINGS CO., LTD., Tokyo (JP)

(21) Appl. No.: 15/267,580

(22) Filed: Sep. 16, 2016

Related U.S. Application Data
(63) Continuation of application No. PCT/JP2015/053709, filed on Feb. 10, 2015.

(30) Foreign Application Priority Data
Mar. 19, 2014 (JP) 2014-057266

(51) Int. Cl. G02F 1/133; G11B 7/0045; H04N 9/31; G02F 1/141; G02F 1/1333

(52) U.S. Cl. CPC G02F 1/13306; G02F 1/141; G02F 1/133382; H04N 9/3126; G11B 7/0045; G02F 2001/1412

(57) ABSTRACT

An optical device includes a liquid crystal shutter using a first liquid crystal material, the liquid crystal shutter controlling application of a light beam to a predetermined point, corresponding to a driving waveform supplied to the liquid crystal shutter; a spatial optical modulator using a second liquid crystal material whose contrast becomes a maximal contrast at a temperature different from that of the first liquid crystal material, the spatial optical modulator modulating the light beam corresponding to a driving waveform supplied to the spatial optical modulator; and a supplying unit that supplies to the liquid crystal shutter and the spatial optical modulator, driving waveforms that are adjusted such that the contrasts of the liquid crystal shutter and the spatial optical modulator each become equal to or greater than 50% of the maximal contrast at a same temperature,

### CROSS REFERENCE TO RELATED APPLICATIONS

This is a continuation application of International Application PCT/JP2015/053709 filed on Feb. 10, 2015 which claims priority from a Japanese Patent Application No. 2014-057266 filed on Mar. 19, 2014, the contents of which are incorporated herein by reference.

### BACKGROUND OF THE INVENTION

1. Field of the Invention

The embodiments discussed herein relate to an optical device that records information to an optical information recording medium.

2. Description of the Related Art

A hologram optical pick-up device is conventional known that records to an optical information recording medium, an information signal by forming a hologram by applying a signal light beam modulated by a spatial light modulator such as a liquid crystal on silicon (LCOS), or that reproduces the information signal by applying a reference light beam to the hologram of the optical information recording medium (see, e.g., Japanese Laid-Open Patent Publication No. 2013-251025).

For the hologram optical pick--up device or the like, a configuration is known that includes a liquid crystal shutter to avoid application of the signal light beam to the optical information recording medium during the writing of the modulated information into the LCOS. In addition to this, various configurations are known that each include a liquid crystal shutter and LCOS inside an optical device such as a projector.

### SUMMARY OF THE INVENTION

According to one aspect of the present invention, an optical device includes a liquid crystal shutter using a first liquid crystal material, the liquid crystal shutter controlling application of a light beam to a predetermined point, corresponding to a driving waveform supplied to the liquid crystal shutter; a spatial optical modulator using a second liquid crystal material whose contrast becomes a maximal contrast at a temperature different from that of the first liquid crystal material, the spatial optical modulator modulating the light beam corresponding to a driving waveform supplied to the spatial optical modulator; and a supplying unit that supplies to the liquid crystal shutter and the spatial optical modulator, driving waveforms that are adjusted such that the contrasts of the liquid crystal shutter and the spatial optical modulator each become equal to or greater than 50% of the maximal contrast at a same temperature.

Objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram of an example of an optical device according to an embodiment;

FIG. 2 is a diagram of an example of states of liquid crystal molecules established when a FLC is used in a liquid crystal layer;

FIG. 3A is a diagram of an example of characteristics of switching angle with respect to temperature of the liquid crystal layer;

FIG. 3B is a diagram of an example of contrast characteristics with respect to temperature of the liquid crystal layer;

FIG. 4A depicts an example of the contrast characteristics with respect to temperature of each of a liquid crystal shutter and a LCOS when each is applied with a driving waveform suitable therefor;

FIG. 4B is a diagram of another example of the contrast characteristics with respect to temperature of each of the liquid crystal shutter and the LCOS when the driving waveforms suitable therefor are applied;

FIG. 5A is a diagram of an example of the characteristics of liquid crystal materials used in the liquid crystal shutter and the LCOS;

FIG. 5B is a diagram of an example of selection of the liquid crystal materials to be used in the liquid crystal shutter 110 and the LCOS 120;

FIG. 5C is a diagram of an example of a gap and a maximal voltage of the driving waveform for each of the liquid crystal shutter 110 and the LCOS 120;

FIG. 6 is a diagram of an example of an optical recording apparatus according to an embodiment;

FIG. 7 is a diagram of an example of a polarization varying element using a ferroelectric liquid crystal;

FIG. 8A is a diagram of an example of the LCOS that uses a ferroelectric liquid crystal;

FIG. 8B is a diagram of an example of light beams in the LCOS depicted in FIG. 8A;

FIG. 9 is a diagram of an example of a configuration of a control unit;

FIG. 10 is a diagram of a modification of the optical recording apparatus according to the embodiment;

FIG. 11A is a diagram of an example of a configuration of a video image engine according to the embodiment;

FIG. 11B is a diagram of a modification of the example of the configuration of the video image engine;

FIG. 12 is a diagram of an example of a configuration of a projector to which the video image engine is applied;

FIG. 13 is a diagram of an example of a utilization form of the projector; and

FIG. 14 is a diagram of a modification of the video image engine according to the embodiment.

### DETAILED DESCRIPTION OF THE INVENTION

Embodiments of the optical device according to the present invention will be described in detail with reference to the accompanying drawings.

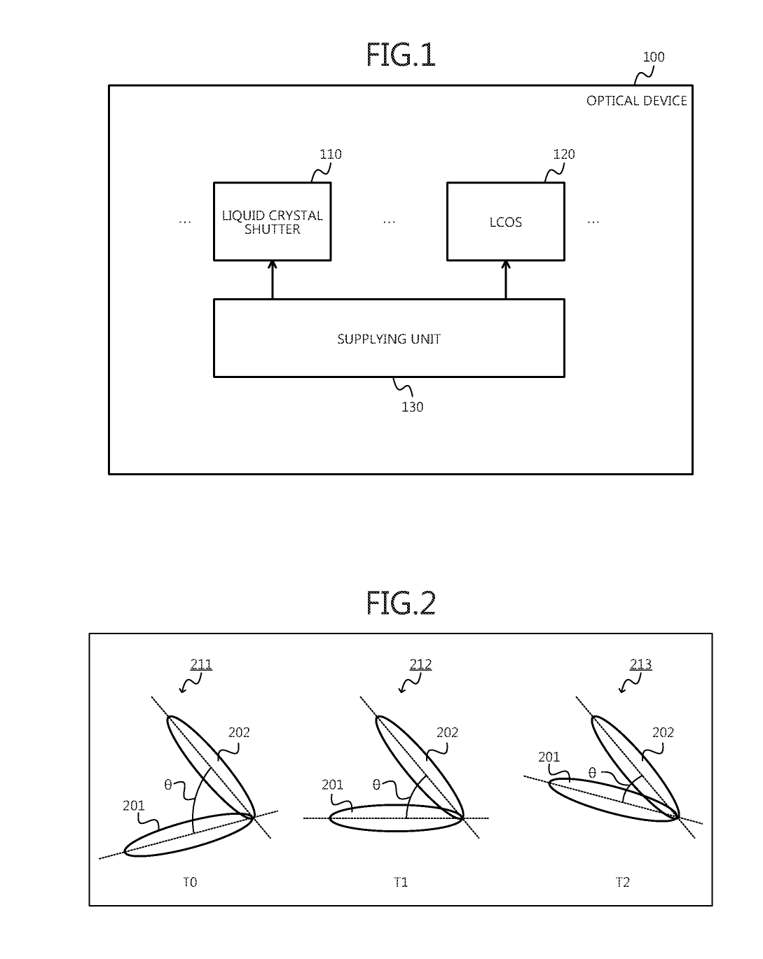

FIG. 1 is a diagram of an example of an optical device according to an embodiment. As depicted in FIG. 1, the optical device 100 according to the embodiment includes a liquid crystal shutter 110, an LCOS 120, and a supplying unit 130.

The liquid crystal shutter 110 is a liquid crystal shutter that uses therein a first liquid crystal material. The liquid crystal shutter 110 controls the application of a light beam to a predetermined point corresponding to a driving waveform supplied thereto. For example, the liquid crystal shutter 110 is a liquid crystal shutter that controls the application of the light beam to a specific point by switching the polarization state of the light beam to be input into a predetermined polarizing optical element. The predetermined polarizing optical element is an element whose transmissivity of a light beam to the specific point differs depending on the polarization state of the light beam.

The predetermined polarizing optical element as an example is a polarizer or polarization beam splitters (PBSs). The predetermined polarizing optical element may be an optical element inside the optical device 100 or may be an optical element outside the optical device 100.

The LCOS 120 is a spatial light modulator that modulates a light beam corresponding to the driving waveform supplied thereto. A liquid crystal element including pixels in a matrix is usable as the spatial light modulator. In this embodiment, an LCOS including high-definition pixels is used as the spatial light modulator. The LCOS 120 uses therein a second liquid crystal material. The second liquid crystal material is a liquid crystal material that is different from the first liquid crystal material used in the liquid crystal shutter 110. For example, the first liquid crystal material and the second liquid crystal material are liquid crystal materials that are different from each other in their characteristics of the switching angle and the torsional angle of their liquid crystal molecules with respect to temperature acquired when driving waveforms having the equal amplitudes are applied thereto.

A ferroelectric liquid crystal (FLC), an anti-ferroelectric liquid crystal (AFLC), or a twisted nematic (TN) liquid crystal is usable in each of the first liquid crystal material and the second liquid crystal material, for example. In particular, a FLC and an AFLC are excellent in terms of response and each have a high contrast, and are therefore advantageous.

The LCOS 120 is disposed to have a relation to be optically in series with the liquid crystal shutter 110. The LCOS 120 is disposed in the upstream from the liquid crystal shutter 110 and modulates a light beam output from the liquid crystal shutter 110.

The LCOS 120 is not thermally isolated from the liquid crystal shutter 110 and is at a temperature substantially equal to that of the liquid crystal shutter 110.

The supplying unit 130 supplies driving waveforms to the liquid crystal shutter 110 and the LCOS 120. In this case, the supplying unit 130 respectively supplies to the liquid crystal shutter 110 and the LCOS 120 driving waveforms that are adjusted such that the contrasts of the liquid crystal shutter 110 and the LCOS 120 are each equal to or greater than 50% of the maximal contrast at the same temperature. For example, the supplying unit 130 respectively supplies to the liquid crystal shutter 110 and the LCOS 120 driving waveforms that are adjusted such that the contrasts of the liquid crystal shutter 110 and the LCOS 120 each become a local maximum (the maximum) at the same temperature.

The contrast of the liquid crystal shutter 110 is the contrast of the light beam produced by controlling the application of the light beam to the predetermined point. For example, the contrast of the liquid crystal shutter 110 is the contrast of a transmitted light beam of the predetermined polarizing optical element produced by switching of the polarization state by the liquid, crystal shutter 110. The contrast of the LCOS 120 is the contrast of the transmitted light beam of the predetermined polarizing optical element after the modulation by the LCOS 120.

According to the configuration depicted in FIG. 1, the contrasts of the liquid crystal shutter 110 and the LCOS 120 can each be set to be equal to or greater than 50% of the maximal contrast at the same temperature. The optical property (the contrast) of the optical device 100 may therefore be improved without, for example, individually adjusting the temperature of each of the liquid crystal shutter 110 and the LCOS 120, and simplification of the apparatus may be facilitated.

For example, because the liquid crystal shutter 110 and the LCOS 120 are not thermally isolated from each other, the temperature control of the liquid crystal shutter 110 and the LCOS 120 may be executed using one temperature adjusting unit inside the optical device 100. For example, when the optical device 100 is disposed in a room whose temperature is controlled and the temperatures of the liquid crystal shutter 110 and the LCOS 120 are stable at the same temperature, configuration may be such that a temperature adjusting unit is not be disposed in the optical device 100.

FIG. 2 is a diagram of an example of states of the liquid crystal molecules established when the FLC is used in the liquid crystal layer. States 201 and 202 of the liquid crystal molecules of switching states 211 to 213 depicted in FIG. 2 are two stable states of the liquid crystal molecules established when voltage is applied to the liquid crystal layers of the liquid crystal shutter 110 and the LCOS 120 depicted in FIG. 1.

The liquid crystal shutter 110 and the LCOS 120 each alternately switch between the states 201 and 202 of the liquid crystal molecules corresponding to the driving waveform supplied thereto. The polarization state of the light beam (the signal light beam) transmitted through the liquid crystal layer is thereby switched. The switching angle θ is the difference in the angles along the direction of the molecular long axis between the states 201 and 202 of the liquid crystal molecules. The contrasts of the liquid crystal shutter 110 and the LCOS 120 each become a local maximum when the switching angle θ is, for example, 45 degrees.

The switching states 211 to 213 represent the states 201 and 202 of the liquid crystal molecules when the temperatures of the liquid crystal shutter 110 are respectively T0 to T2 (T0<T1<T2). As represented by the switching states 211 to 213, the states 201 and 202 (the switching angle θ) of the liquid crystal shutter 110 varies with the temperature of the liquid crystal shutter 110.

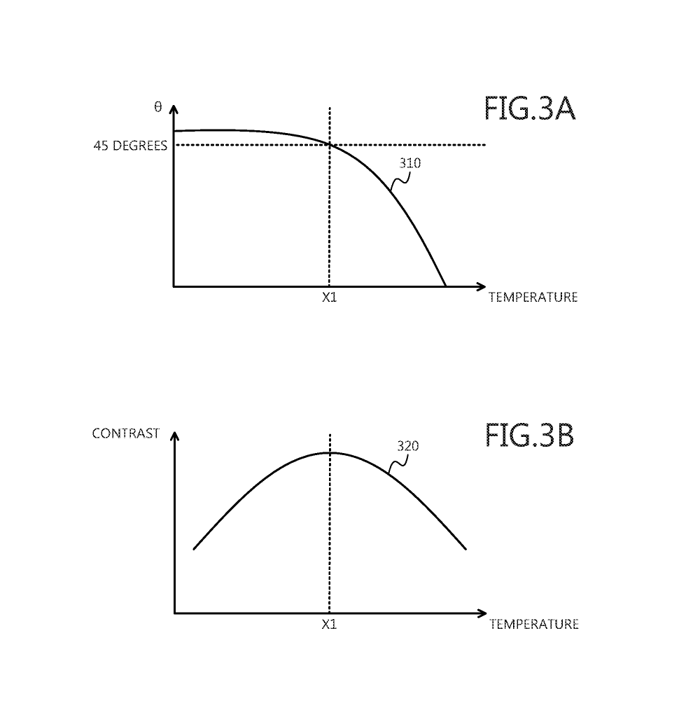

FIG. 3A is a diagram of an example of the characteristics of the switching angle with the temperature of the liquid crystal layer. In FIG. 3A, the axis of abscissa represents the temperature of the liquid crystal layer and the axis of ordinate represents the switching angle θ of the liquid crystal layer. The temperature switching angle curve 310 represents the characteristics of the switching angle θ with respect to temperature in the liquid crystal layer of each of the liquid crystal shutter 110 and the LCOS 120. A temperature X1 represents the temperature of the liquid crystal layer at which the switching angle θ is 45 degrees in the temperature switching angle curve 310.

As described, the liquid crystal shutter 110 and the LCOS 120 each use therein a liquid crystal material different from that of each other. The liquid crystal shutter 110 and the LCOS 120 are each driven by a driving waveform different from that of each other. The temperature switching angle curve 310 therefore differs between the liquid crystal shutter 110 and the LCOS 120 when the liquid crystal shutter 110 and the LCOS 120 are each applied with the driving waveform suitable therefor. When the liquid crystal shutter 110 and the LCOS 120 are each applied with the driving waveform suitable therefor, the temperature X1 at which the switching angle θ is 45 degrees differs between the liquid crystal shutter 110 and the LCOS 120.

FIG. 3B is a diagram of an example of the characteristics of the contrast with respect to temperature of the liquid crystal layer. In FIG. 3B, the axis of abscissa represents the temperature of the liquid crystal layer and the axis of ordinate represents the contrast of the liquid crystal layer. A temperature contrast curve 320 represents the characteristics of the contrasts of the liquid crystal shutter 110 and the LCOS 120 with respect to the temperature of the liquid crystal layer of each of the liquid crystal shutter 110 and the LCOS 120 when the driving waveform suitable therefor is applied. The temperature X1 represents the temperature of the liquid crystal shutter 110 at which the switching angle θ of the liquid crystal shutter 110 is 45 degrees as depicted in FIG. 3A. In the temperature contrast curve 320, the contrast becomes a local maximum when the temperature is X1.

As described, the temperature X1 at which the switching angle θ is 45 degrees differs between the liquid crystal shutter 110 and the LCOS 120 when the liquid crystal shutter 110 and the LCOS 120 are each supplied with the driving waveform suitable therefor. The temperature X1 at which the contrast becomes the local maximum also differs between the liquid crystal shutter 110 and the LCOS 120 when the liquid crystal shutter 110 and the LCOS 120 are each supplied with the same driving waveform.

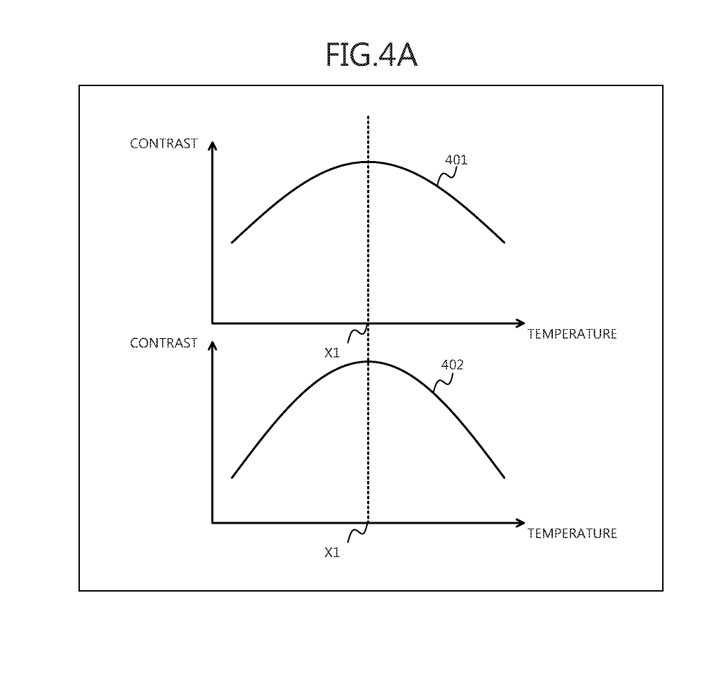

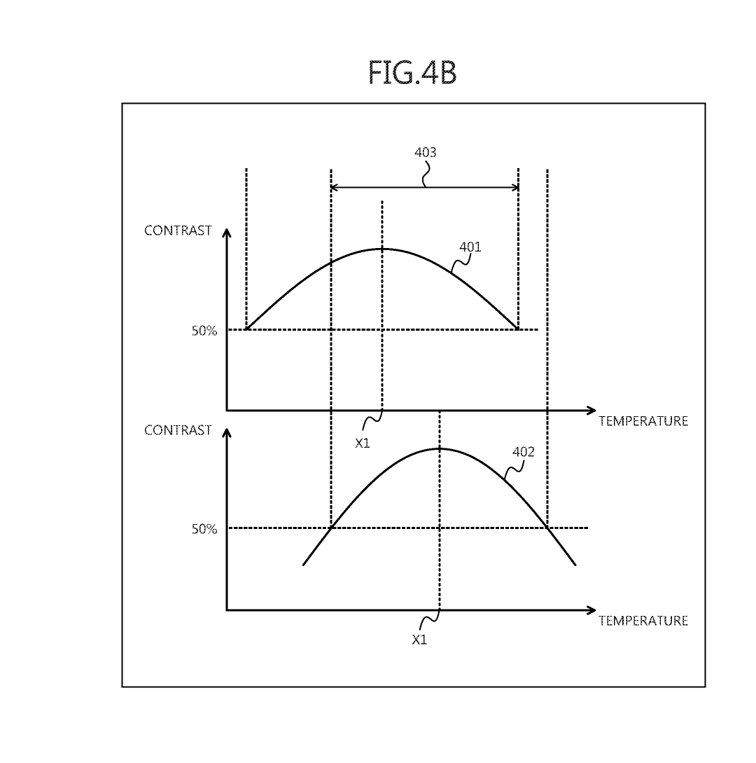

FIG. 4A depicts an example of the contrast characteristics with respect to temperature of each of the liquid crystal shutter and the LCOS when each is applied with the driving waveform suitable therefor. In FIG. 4A, the axis of abscissa represents the temperature of the liquid crystal layer and the axis of ordinate represents the contrast of the liquid crystal layer. A temperature contrast curve 401 represents the characteristics of the contrast with respect to the temperature of the liquid crystal layer of the liquid crystal shutter 110. A temperature contrast curve 402 represents the characteristics of the contrast with respect to the temperature of the liquid crystal layer of the LCOS 120.

As represented by the temperature contrast curves 401 and 402, in the optical device 100, both of the temperature contrast curves 401 and 402 are employed as, for example, the temperature contrast characteristics with which the contrasts become the local maxima at the same temperature X1, by adjusting the driving waveforms to be supplied to the liquid crystal shutter 110 and the LCOS 120 and using the optimal materials.

The contrasts of the liquid crystal shutter 110 and the LCOS 120 may thereby be set to be their local maxima by maintaining the temperature of the liquid crystal shutter 110 and the LCOS 120 at X1. X1 may be set to be 40° C., for example.

FIG. 4B is a diagram of another example of the contrast characteristics with respect to temperature of each of the liquid crystal shutter and the LCOS when the driving waveforms suitable therefor are applied. In FIG. 4B, portions identical to those depicted in FIG. 4A are given the same reference numerals used in FIG. 1A and will not again be described. A case is described where both of the temperature contrast curves 401 and 402 are employed as the temperature contrast characteristics by which the contrasts become the local maxima at the same temperature X1 with reference to FIG. 4A while, in practice, the contrasts of the liquid crystal shutter 110 and the LCOS 120 may each be, for example, equal to or greater than ½ (50%) of the maximal contrast at the same temperature. The maximal contrast of each of the temperature contrast curves 401 and 402 is, for example, each of the local maximal values of the temperature contrast curves 401 and 402.

For example, as depicted in FIG. 4B, the temperature X1 at which the contrast becomes a local maximum in the temperature contrast curve 401 of the liquid crystal shutter 110 and the temperature X1 at which the contrast becomes a local maximum in the temperature contrast curve 402 of the LCOS 120 may be shifted with respect to each other. In this case, the driving waveforms to be supplied to the liquid crystal shutter 110 and the LCOS 120 are adjusted and the materials optimal for the liquid crystal shutter 110 and the LCOS 120 are used such that the contrast of each of the temperature contrast curves 401 and 402 is equal to or greater than 50% of the maximal contrast at the same temperature. A usable temperature range 403 depicted in FIG. 4B is a temperature range within which the contrast is equal to or greater than 50% of the maximal contrast in each of the temperature contrast curves 401 and 402.

The transmissivity of each of the liquid crystal shutter 110 and the LCOS 120 depends on the switching angle thereof, and the switching angle depends on the temperature. For example, in a case where an FLC material is used as the liquid crystal material of the liquid crystal shutter 110 and the LCOS 120, at a temperature equal to or less than 50° C., the temperature dependence property of the switching angle is a property for the variation of the switching angle to be equal to or less than ±1 degree when the temperature varies by ±2.5° C. When the variation of the switching angle is equal to or less than ±1 degree, the variation of the transmissivity is a modicum of 0.001% or less.

Even when the liquid crystal device and the angle of the incident polarized light beam are brought into their optimal states for an actual device, however, micro light beam leakages are present due to the properties of a polarizing plate and the PBS, and the variation of the transmissivity is thereby about 0.001%. When the switching angle is shifted by about ±1 degree, the contrast becomes about ½ while the contrast may be about ½ in practice.

For example, in practice, it may be difficult to establish both of the temperature contrast curves 401 and 402 as the temperature contrast characteristics to cause the contrasts to take local maxima at the same temperature X1 due to problems of the mechanical precision of a panel, the precision of a used heater and a used thermometer, and the like. The designing of the optical device 100 is however usually executed in anticipation of an occurrence of a deviation of about ±1 degree of the switching angle, that is, the contrast that is equal to or greater than 50% of the maximal contrast, and the contrast only has to therefore be equal to or greater than about ½.

Assuming that the contrasts of the liquid crystal shutter 110 and the LCOS 120 are each lower than ½ (50%) of the maximal contrast, the precision of the measurement data is degraded. For example, when the optical device 100 is applied to an optical recording apparatus such as a holographic memory, an error occurs in the information written into an optical recording medium (for example, an optical disk).

As described, in an optical recording apparatus such as, for example, a holographic memory, the contrasts of the liquid crystal shutter 110 and the LCOS 120 merely have to each be equal to or greater than 50% of the maximal contrast thereof at a same temperature. To realize this for example, the difference in the temperature causing the contrast to be the local maximum value between the liquid crystal shutter 110 and the LCOS 120 merely has to be within ±2.5 degrees (the deviation of the switching angle therebetween is equal to or less than ±1 degree).

The contrast may be defined as “the transmissivity of white/the transmissivity of black”. The transmissivity of white is the transmissivity of the light beam when the liquid crystal shutter 110 does not block the light beam. The transmissivity of black is the transmissivity of the light beam when the liquid crystal shutter 110 blocks the light beam.

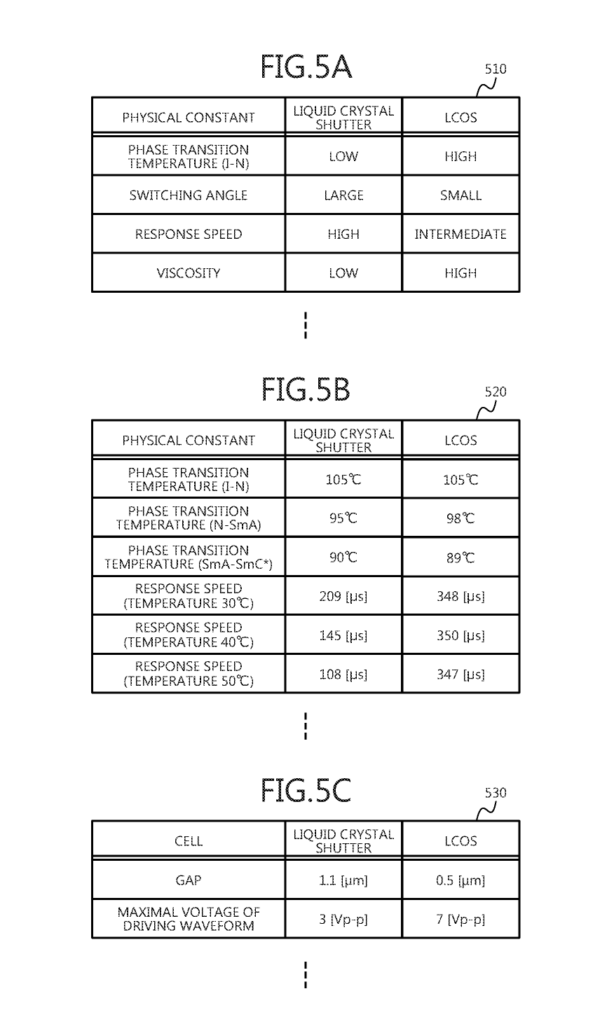

FIG. 5A is a diagram of an example of the characteristics of the liquid crystal materials used in the liquid crystal shutter and the LCOS. The required characteristics are different between the liquid crystal shutter 110 and the LCOS 120. The liquid crystal shutter 110 and the LCOS 120 each therefore use therein a liquid crystal material that is different from that of each other as above. For example, the liquid crystal material giving priority to response speed is used in the liquid crystal shutter 110. The liquid crystal material giving priority to transmissivity is used in the LCOS 120.

A table 510 depicted in FIG. 5A shows the physical constants required of the liquid crystal shutter 110 and the LCOS 120. For example, the liquid crystal shutter 110 uses therein a liquid crystal material whose phase transition temperature (I-N) for transition from the isotropic phase to the nematic phase is low compared to that of the LCOS 120.

The liquid crystal shutter 110 uses therein a liquid crystal material whose switching angle θ is large compared to that of the LCOS 120. The liquid crystal shutter 110 uses therein a liquid crystal material whose response speed is high compared to that of the LCOS 120. The liquid crystal shutter 110 uses therein a liquid crystal material whose viscosity is low compared to that of the LCOS 120. In addition, the required physical constants such as the spontaneous polarization are different between the liquid crystal shutter 110 and the LCOS 120.

FIG. 5B is a diagram of an example of the selection of the liquid crystal materials to be used in the liquid crystal shutter 110 and the LCOS 120. The liquid crystal materials having the characteristics shown in a table 520 of FIG. 5B may be employed as the liquid crystal materials of the liquid crystal shutter 110 and the LCOS 120 as an example.

In the example shown in the table 520, the physical constants each different between the liquid crystal materials used in the liquid crystal shutter 110 and the LCOS 120 include the phase transition temperature (I-N) for the transition from the isotropic phase to the nematic phase, the phase transition temperature (N-SmA) for the transition from the nematic phase to the smectic-A phase, the phase transition temperature (SmA-SmC*) for the transition from the smectic-A phase to the smectic-C phase, and the response speed at each of temperatures (30° C., 40° C., and 50° C.)

FIG. 5C is a diagram of an example of a gap and a maximal voltage of the driving waveform for each of the liquid crystal shutter 110 and the LCOS 120. The maximal voltages of the driving waveforms to be supplied to the liquid crystal shutter 110 and the LCOS 120 are also limited by the gap (the cell gap) and the like of the liquid crystal shutter 110 and the LCOS 120. The driving waveforms to be supplied to the liquid crystal shutter 110 and the LCOS 120 may therefore be determined corresponding to the gaps and the temperature contrast characteristics 320 of the liquid crystal shutter 110 and the LCOS 120.

For example, in the example shown in a table 530 of FIG. 5C, when the gaps of the liquid crystal shutter 110 and the LCOS 120 respectively are 1.1 [μm] and 0.5 [μm], the amplitudes of the driving waveforms for the liquid crystal shutter 110 and the LCOS 120 are respectively set to be 3 [Vp-p] and 7 [Vp-p].

For example, a design engineer of the optical device 100 selects the liquid crystal materials of the liquid crystal shutter 110 and the LCOS 120 based on the characteristics required of the liquid crystal shutter 110 and the LCOS 120. The selection of the liquid crystal materials may be made by, for example, selecting the types of the liquid crystal materials, blending plural types of liquid crystal material, and the like.

For the liquid crystal shutter 110 using therein the selected liquid crystal material, the design engineer detects the contrast of the liquid crystal shutter 110 varying the temperature of the liquid crystal shutter 110 and identifies the temperature of the liquid crystal shutter 110 at which the contrast becomes the local maximum. The detection of the contrast may be executed by, for example, detecting the light beam output from the liquid crystal shutter 110 using a photo detector (PD).

The design engineer executes the identification of the temperature of the liquid crystal shutter 110 at which the contrast becomes its local maximum for plural driving waveforms by which the liquid crystal shutter 110 may operate. The temperature of the liquid crystal shutter 110 at which the contrast becomes its local maximum may thereby be identified for the plural driving waveforms for the liquid crystal shutter 110.

For the LCOS 120, similarly, for the LCOS 120 using therein the selected liquid crystal material, the design engineer detects the contrast of the LCOS 120 by varying the temperature of the LCOS 120 and identifies the temperature of the LCOS 120 at which the contrast becomes its local maximum. The design engineer executes the identification of the temperature of the LCOS 120 at which the contrast becomes its local maximum for plural driving waveforms by which the LCOS 120 may operate. The temperature of the LCOS 120 at which the contrast becomes the local maximum may thereby be identified for the plural driving waveforms for the LCOS 120.

The design engineer selects a combination by which the identified temperatures are equal to each other among combinations of the driving waveforms for the liquid crystal shutter 110 and the LCOS 120. The design engineer may determine the combination of the driving waveforms for the liquid crystal shutter 110 and the LCOS 120, by which the temperatures are equal to each other at which the contrasts become the local maxima.

The design engineer may design as follows such that the contrasts of the liquid crystal shutter 110 and the LCOS 120 are each equal to or greater than 50% of the maximal contrast at the same temperature. For the liquid crystal shutter 110 using therein the selected liquid crystal material, the design engineer detects the contrast of the liquid crystal shutter 110 varying the temperature of the liquid crystal shutter 110 and identifies a temperature range for the liquid crystal shutter 110 within which the contrast is equal to or greater than 50% of the maximal contrast.

The design engineer executes the identification of the temperature range for the liquid crystal shutter 110 within which the contrast is equal to or greater than 50% of the maximal contrast for the plural driving waveforms by which the liquid crystal shutter 110 may operate. The design engineer may thereby identify the temperature range for the liquid crystal shutter 110 within which the contrast is equal to or greater than 50% of the maximal contrast for the plural driving waveforms for the liquid crystal shutter 110.

For the LCOS 120, similarly, for the LCOS 120 using therein the selected liquid crystal material, the design engineer detects the contrast of the LCOS 120 varying the temperature of the LCOS 120 and identifies the temperature range of the LCOS 120 within which the contrast is equal to or greater than 50% of the maximal contrast. The design engineer executes the identification of the temperature range of the LCOS 120 within which the contrast is equal to or greater than 50% of the maximal contrast for the plural driving waveforms by which the LCOS 120 may operate. The design engineer may thereby identify the temperature range of the LCOS 120 within which the contrast is equal to or greater than 50% of the maximal contrast for the plural driving waveforms for the LCOS 120.

The design engineer selects a combination by which at least a portion of each of the identified temperature ranges overlaps with each other, among the combinations of the driving waveforms for the liquid crystal shutter 110 and the LCOS 120. The design engineer may thereby determine the combination of the driving waveforms for the liquid crystal shutter 110 and the LCOS 120, by which the contrasts are each equal to or greater than 50% of the maximal contrast at the same temperature.

The design engineer may select the combination of the driving waveforms for the liquid crystal shutter 110 and the LCOS 120 such that the width of the overlapping portions (for example, the usable temperature range 403 of FIG. 4B) of the identified temperature ranges is equal to or greater than the temperature variation range of the environment of the optical device 100. The contrasts of the liquid crystal shutter 110 and the LCOS 120 may thereby be set to be equal to or greater than 50% of the maximal contrasts at the same temperature even when temperature variation of the optical device 100 is present.

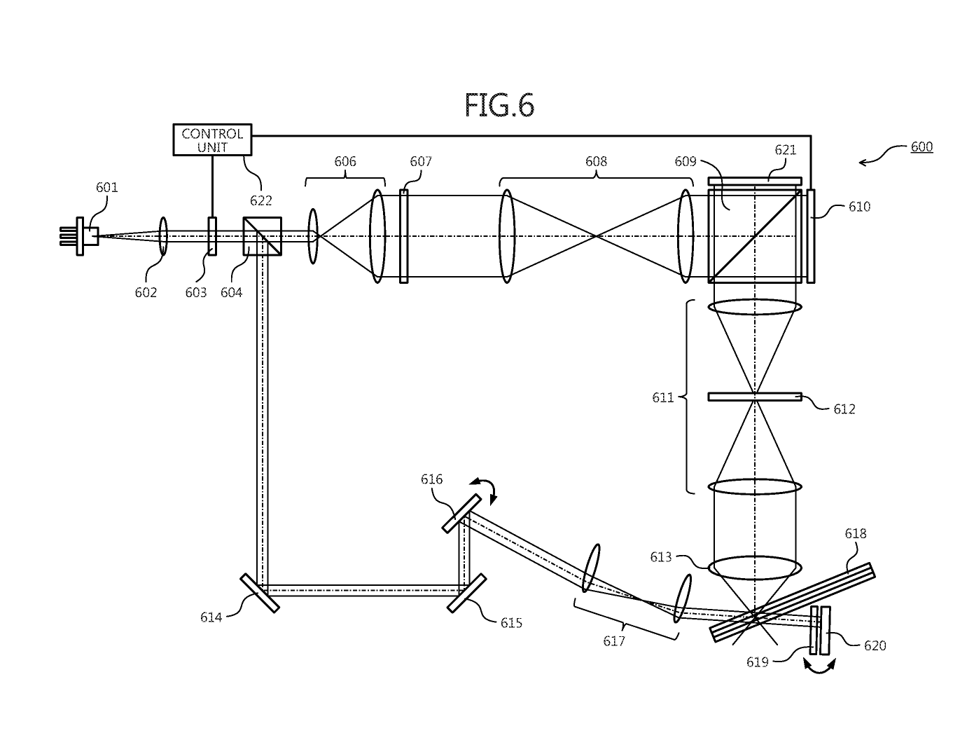

FIG. 6 is a diagram of an example of an optical recording apparatus according to the embodiment. The optical device 100 depicted in FIG. 1 may be realized by the optical recording apparatus 600 depicted in FIG. 6, for example. The optical recording apparatus 600 includes a light source 601, a collimating lens 602, a polarization varying element 603, PBS prisms 604 and 609, a beam expander 606, a phase mask 607, relay lenses 608 and 611, an LCOS 610, a spatial filter 612, an objective lens 613, mirrors 614 and 615, galvanometer mirrors 616 and 620, a scanner lens 617, an optical information recording medium 618, a quarter-wave plate 619, an imaging element 621, and a control unit 622.

The optical recording apparatus 600 records information to the optical information recording medium 618 by applying a signal light beam spatially modulated by the LCOS 610 to the optical information recording medium 618. The optical recording apparatus 600 reads information by converting a reproduction light beam obtained by applying a reference light beam to the optical information recording medium 618, into an electric signal using the imaging element 621.

The optical device 100 depicted in FIG. 1 may be realized by, for example, the optical recording apparatus 600. In this case, the liquid crystal shutter 110 depicted in FIG. 1 may be realized by, for example, the polarization varying element 603. The predetermined polarization optical element is, for example, the PBS prism 604. The LCOS 120 depicted in FIG. 1 may be realized by, for example, the LCOS 610. The supplying unit 130 depicted in FIG. 1 may be realized by, for example, the control unit 622.

The light source 601 emits a light beam to the collimating lens 602. The light beam output from the light source 601 may be set to be, for example, a continuous light beam of predetermined linear polarization. For example, a laser diode (LD) is usable as the light source 601. The collimating lens 602 collimates the light beam output from the light source 601 into a light beam having a predetermined beam diameter, and injects the collimated light beam into the polarization varying element 603.

The polarization varying element 603 adjusts the polarization state of the light beam output from the collimating lens 602 corresponding to the driving waveform supplied from the control unit 622. For example, when the information is recorded to the optical information recording medium 618, the polarization varying element 603 sets the polarization state of the light beam to be a polarization state that includes P-polarization and S-polarization.

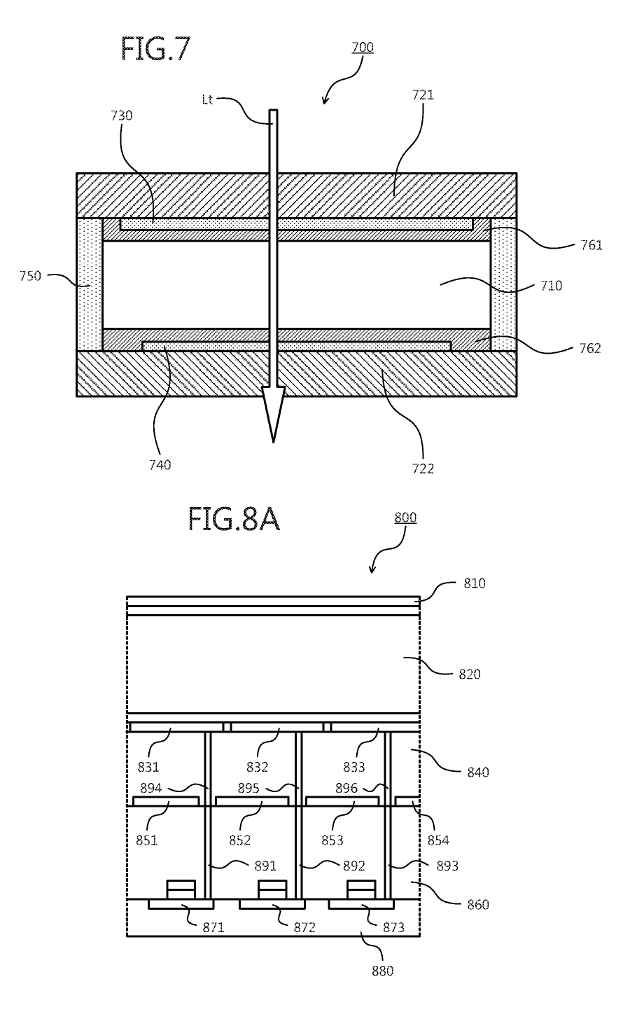

When information is reproduced from the optical information recording medium 618, the polarization varying element 603 sets the polarization state of the light beam to be S-polarization. The polarization varying element 603 outputs the light, beam whose polarization state is adjusted, to the PBS prism 604. For example, an FLC, an AFLC, or a TN liquid crystal is usable as the polarization varying element 603 (see, for example, FIG. 7).

The PBS prism 604 is a PBS that transmits therethrough the P-polarization light beam output from the polarization varying element 603 and that outputs this light beam to the beam expander 606 as a signal light beam. The PBS prism 604 reflects the S-polarization light beam output from the polarization varying element 603 and outputs this light beam to the mirror 614 as a reference light beam. The P-polarization signal light beam is thereby output to the beam expander 606 and the S-polarization reference light beam is thereby output to the mirror 614 when the information is recorded into the optical information recording medium 618. The S-polarization reference light beam is output to the mirror 614 when the information is reproduced from the optical information recording medium 618.

The beam expander 606 expands the beam diameter of the signal light beam output from the PBS prism 604 to a predetermined beam diameter and injects the signal light beam whose beam diameter is expanded into the phase mask 607. The signal light beam injected from the beam expander 606 into the phase mask 607 is output to the PBS prism 609 through the phase mask 607 and the relay lenses 608.

The PBS prism 609 transmits therethrough the P-polarization signal light beam output from the relay lenses 608 and outputs this signal light beam to the LCOS 610. The PBS prism 609 reflects the signal light beam output from the LCOS 610 and outputs this signal light beam to the relay lenses 611. The signal light beam output from the PBS prism 609 to the relay lenses 611 is output to the optical information recording medium 618 through the relay lenses 611, an opening of the spatial filter 612, and the objective lens 613.

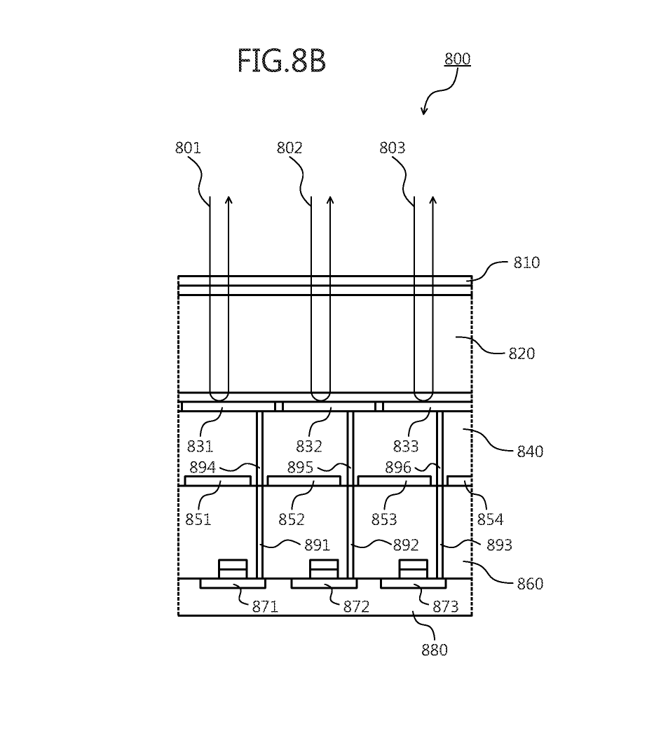

The LCOS 610 spatially modulates the signal light beam output from the PBS prism 609 based on modulation information. For example, the LCOS 610 executes the modulation based on the driving waveform indicating the two-dimensional image data (the modulation information) output from the control unit 622. The LCOS 610 injects the modulated signal light beam into the PBS prism 609. For example, an FLC or an AFLC is usable in the LCOS 610 (see, for example, FIGS. 8A and 8B).

The reference light beam output from the PBS prism 604 to the mirror 614 is output to the galvanometer mirror 616 through the mirrors 614 and 615. The galvanometer mirror 616 reflects the reference light beam output from the mirror 615 and outputs the reference light beam to the scanner lens 617. The angle control for the galvanometer mirror 616 may be executed by, for example, the control unit 622. The scanner lens 617 injects the reference light beam output from the galvanometer mirror 616 into the optical information recording medium 618.

For example, various types of optical information recording medium such as a photorefractive crystal such as that of lithium niobate, and a photosensitive resin material (a photopolymer) are each usable in the optical information recording medium 618. The optical information recording medium 618 may be able to be displaced by, for example, the control from the control unit 622.

When information is recorded, the signal light beam output from the objective lens 613 and the reference light beam output from the scanner lens 617 enter the optical information recording medium 618 to be overlapped with each other. An interference stripe pattern is thereby formed on the optical information recording medium 618 and the optical information recording medium 618 records the interference stripe pattern formed thereon as a hologram. Angle multiplexing recording may be executed by varying the incidence angle of the reference light beam against the optical information recording medium 618 by controlling the angle of the galvanometer mirror 616. In this embodiment, this hologram is referred to as “page” and a recording area having the pages angle-multiplexed therein is referred to as “hook”.

When the information is reproduced, the reference light beam output from the scanner lens 617 enters the optical information recording medium 618. The quarter-wave plate 619 transmits therethrough the reference light beam output from the scanner lens 617 and transmitted through the optical information recording medium 618, and outputs the reference light beam to the galvanometer mirror 620.

The galvanometer mirror 620 reflects the reference light beam output from the quarter-wave plate 619 at a variable angle. The angle control for the galvanometer mirror 620 may be executed by, for example, the control unit 622. In this case, the angle control for the galvanometer mirror 620 is executed in tandem with the angle control for the galvanometer mirror 616 and the reference light beam is thereby reflected substantially perpendicularly to the galvanometer mirror 620, and the reference light beam is returned to the quarter-wave plate 619.

The reference light beam output from the scanner lens 617 and transmitted through the optical information recording medium 618 passes through the quarter-wave plate 619 twice and is thereby converted from the S-polarization light beam into a P-polarization light beam to be output to the optical information recording medium 618. A reproduction light beam corresponding to the information recorded in the optical information recording medium 618 is thereby output to the objective lens 613 as a P-polarization diffracted light beam.

The reproduction light beam output from the optical information recording medium 618 to the objective lens 613 enters the PBS prism 609 through the objective lens 613 and the relay lenses 611. Here, only the reproduction light beam to be the diffracted light beam from a book to be reproduced is transmitted to the PBS prism 609 by an opening of the spatial filter 612 between the relay lenses 611.

The PBS prism 609 transmits therethrough the P-polarization reproduction light beam output from the relay lenses 611 and injects the reproduction light beam into the imaging element 621.

The imaging element 621 converts the reproduction light beam output from the PBS prism 609 into an electric signal. The electric signal that indicates the information recorded in the optical information recording medium 618 may thereby be obtained. The imaging element 621 outputs the converted electric signal. The electric signal output from the imaging element 621 is output to, for example, the outside of the optical recording apparatus 600. For example, a solid-state imaging element such as that of a complementary metal oxide semiconductor (CMOS), or the like is usable as the imaging element 621.

The control unit 622 controls the LCOS 610, the polarization varying element 603, and the like when information is recorded to the optical information recording medium 618 or when information is reproduced from the optical information recording medium 618.

For example, when information is recorded to the optical information recording medium 618, the control unit 622 supplies (writes) a driving waveform indicating the information (modulation information) to be recorded, to/into the LCOS 610 and supplies a driving waveform to the polarization varying element 603 such that the signal light beam and the reference light beam are output from the PBS prism 604. When the information is written to the LCOS 610 even in the case where the information is recorded to the optical information recording medium 618, however, the control unit 622 supplies a driving waveform to the polarization varying element 603 such that the signal light beam does not exit from the PBS prism 604.

When the information is reproduced from the optical information recording medium 618, the control unit 622 supplies a driving waveform to the polarization varying element 603 such that only the reference light beam is output from the PBS prism 604.

When the information is recorded into the optical information recording medium 618, the control unit 622 controls a book to be recorded and the like by controlling the angle of the galvanometer mirror 616. When the information is reproduced from the optical information recording medium 618, the control unit 622 controls the book to be reproduced and the like by controlling the angle of each of the galvanometer mirrors 616 and 620. In FIG. 6, the connection relation between the control unit 622 and the galvanometer mirrors 616 and 620 is not depicted. The control unit 622 may move the book to be recorded by varying the position of the optical information recording medium 618 relative to that or the objective lens 613.

The contrasts of the LCOS 610, the polarization varying element 603, and the PBS prism 604 may be enhanced by applying the optical device 100 to the optical recording apparatus 600 and, for example, improvement of the precision of the recording into the optical information recording medium 618 can therefore be facilitated.

FIG. 7 is a diagram of an example of the polarization varying element using a ferroelectric liquid crystal. For example, a liquid crystal cell 700 depicted in FIG. 7 is usable as the polarization varying element 603 depicted in FIG. 6. The liquid crystal cell 700 is a ferroelectric liquid crystal cell (a liquid crystal module) that includes a ferroelectric liquid crystal layer 710, glass substrates 721 and 722, a common electrode 730, a signal electrode 740, a sealing material 750, and orientation films 761 and 762. The ferroelectric liquid crystal layer 710 is a ferroelectric liquid crystal layer that has two table states (for example, the liquid crystal molecule states 201 and 202 depicted in FIG. 2).

The glass substrates 721 and 722 are a pair of glass substrates that hold the ferroelectric liquid crystal layer 710 sandwiching this layer 710 therebetween. The glass substrates 721 and 722 are bonded to each other by the sealing material 750. The common electrode 730 and the signal electrode 740 as driving electrodes to be transparent electrodes are disposed respectively on the faces of the glass substrates 721 and 722 that face each other, and the orientation films 761 and 762 are respectively disposed on the common electrode 730 and the signal electrode 740. “Lt” denotes a light beam transmitted through the liquid crystal cell 700.

FIG. 8A is a diagram of an example of the LCOS that uses the ferroelectric liquid crystal. The LCOS 610 depicted in FIG. 6 may be realized by, for example, a reflective LCOS 800 depicted in FIG. 8A. The reflective LCOS 800 includes a transparent electrode substrate 810, a ferroelectric liquid crystal layer 820, reflective electrodes 831 to 833, silicon oxide film layers 840 and 860, light blocking layers 851 to 854 that are reflecting members, transistors 871 to 873, a silicon layer 880, contact holes 891 to 893, and vias 894 to 896.

The reflective LCOS 800 is a reflective liquid crystal optical element that has the ferroelectric liquid crystal layer 820 sandwiched between the silicon oxide film layer 840 having the reflective electrodes 831 to 833 disposed thereon, and the transparent electrode substrate 810, and that reflects the light beam transmitted through the transparent electrode substrate 810 and the ferroelectric liquid crystal layer 820 using the reflective electrodes 831 to 833 to cause the light beam to be output from the transparent electrode substrate 810.

The transparent electrode substrate 810 may be formed by, for example, stacking a glass substrate and a transparent electrode on each other. The transparent electrode may be formed using, for example, indium tin oxide (ITO). In this case, the transparent electrode substrate 810 may be formed by, for example, coating ITO on a glass substrate. Voltage is applied to the transparent electrode substrate 810 from, for example, a control board of the reflective LCOS 800.

The ferroelectric liquid crystal layer 820 is a ferroelectric liquid crystal layer that is disposed between the transparent electrode substrate 810 and the reflective electrodes 831 to 833 and that has two stable states (for example, the liquid crystal molecule states 201 and 202 depicted in FIG. 2). The ferroelectric liquid crystal layer 820 varies its liquid crystal orientation corresponding to the voltage applied between the transparent electrode substrate 810 and the reflective electrodes 831 to 833.

The reflective electrodes 831 to 833 are reflective pixel electrodes that each reflect a light beam. The reflective electrodes 831 to 833 are disposed on the silicon oxide film layer 840 to be, for example, at equal intervals and with gaps in between. The reflective electrodes 831 to 833 may each be formed using, for example, aluminum.

FIG. 8A depicts only a portion of the reflective LCOS 800 and therefore depicts only the reflective electrodes 831 to 833 as the reflective electrodes although the reflective LCOS 800 may include more reflective electrodes. FIG. 8A depicts only the reflective electrodes 831 to 833 that are aligned in a one-dimensional direction although the reflective electrodes of the reflective LCOS 800 are disposed in two-dimensional directions (that is, in a matrix) relative to the silicon oxide film layer 840.

The silicon oxide film layer 840 is an SiO₂ (silicon dioxide) layer disposed between the reflective electrodes 831 to 833 and the light blocking layers 851 to 854. The vias 894 to 896 are disposed in the silicon oxide film layer 840, each penetrates the silicon oxide film layer 840 and respectively connects the reflective electrodes 831 to 833 and the contact holes 891 to 893.

The light blocking layers 851 to 854 are each a light blocking layer that blocks any light beam travelling from the, silicon oxide film layer 840 to the silicon oxide film layer 860. The light blocking layers 851 to 854 are the reflecting members that reflect light beams transmitted through the gaps among the reflective electrodes 831 to 833 of the light beams transmitted through the ferroelectric liquid crystal layer 820. The light blocking layers 851 to 854 may each be formed by using, for example, aluminum.

FIG. 8A depicts only the portion of the reflective LCOS 800 and therefore depicts only the light blocking layers 851 to 854 as the light blocking layers although the reflective LCOS 800 may include more light blocking layers. FIG. 8A depicts only the light blocking layers 851 to 854 that are aligned in a one-dimensional direction although the light blocking layers of the reflective LCOS 800 are disposed in two-dimensional directions relative to the silicon oxide film layer 840.

The silicon oxide film layer 860 is an SiO₂ (silicon dioxide) layer disposed between the light blocking layers 851 to 854 and the silicon layer 880. The contact holes 891 to 893 are disposed in the silicon oxide film layer 860, each penetrates the silicon oxide film layer 860 and the contact holes 891 to 893 respectively connect the vias 894 to 896 and the transistors 871 to 873.

The silicon layer 880 has the transistors 871 to 873 disposed therein. The transistors 871 to 873 respectively apply voltages to the reflective electrodes 831 to 833 through the contact holes 891 to 893 and the vias 894 to 896.

FIG. 8A depicts only the portion of the reflective LCOS 800 and therefore depicts only the transistors 871 to 873 as the transistors although the reflective LCOS 800 includes transistors corresponding to the reflective electrodes. FIG. 8A depicts only the transistors 871 to 873 that line in a one-dimensional direction although the transistors of the reflective LCOS 800 are disposed in two-dimensional directions relative to the silicon oxide film layer 840 corresponding to the reflective electrodes.

FIG. 8B is a diagram of an example of the light beams in the LCOS depicted in FIG. 8A. In FIG. 8B, portions identical to the portions depicted in FIG. 8A are given the same reference numerals used in FIG. 8A and will not again be described. A light beam enters the reflective LCOS 800 perpendicularly thereto from, for example, the transparent electrode substrate 810.

Light beams 801 to 803 depicted in FIG. 8B are the light beams that respectively enter the reflective electrodes 831 to 833 of the light beams entering the reflective LCOS 800 and transmitted through the ferroelectric liquid crystal layer 820. The light beams 801 to 803 are respectively reflected by the reflective electrodes 831 to 833, are transmitted through the ferroelectric liquid crystal layer 820, and exit from the transparent electrode substrate 810. The liquid crystal orientations of the portions transmitting therethrough the light beams 801 to 803 in the ferroelectric liquid crystal layer 820 are varied by the voltages respectively applied to the reflective electrodes 831 to 833 by the transistors 871 to 873.

The light beams 801 to 803 are thereby modulated respectively corresponding to the voltages applied to the reflective electrodes 831 to 833 by the transistors 871 to 873, and the modulated light beams 801 to 803 exit from the transparent electrode substrate 810.

The portions are depicted in FIGS. 8A and 8B whose scales are different from those of the actual dimensions.

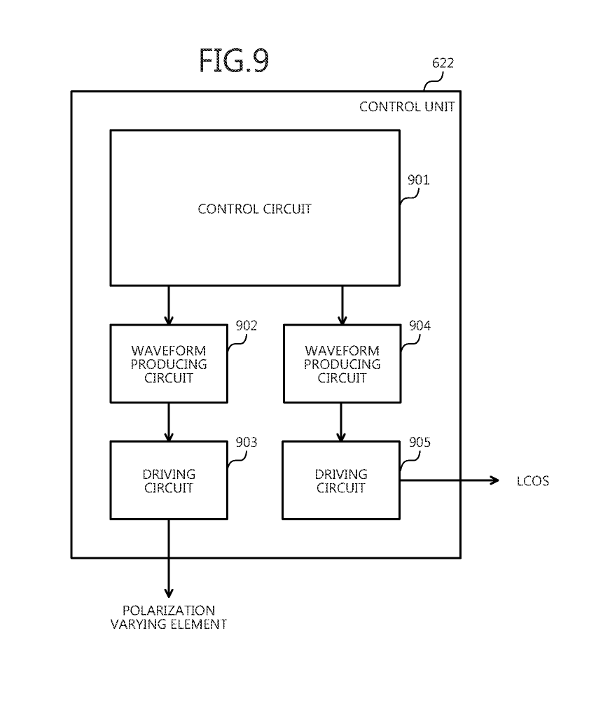

FIG. 9 is a diagram of an example of the configuration of the control unit. As depicted in FIG. 9, the control unit 622 depicted in FIG. 6 includes, for example, a control circuit 901, waveform producing circuits 902 and 904, and driving circuits 903 and 905.

The control unit 622 controls writing of modulated information (two-dimensional image data) into the LCOS 610, the driving waveform to be supplied to the polarization varying element 603, and the like. Though not depicted, the control unit 622 may control the angles of the galvanometer mirrors 616 and 620, the move of the optical information recording medium 618, and the like.

For example, the control circuit 901 outputs to the waveform producing circuit 902, a signal that indicates the waveform pattern of the driving waveform of the polarization varying element 603. The waveform producing circuit 902 produces a waveform signal of a voltage waveform based on the signal output from the control circuit 901, and outputs the produced waveform signal to the driving circuit 903. The driving circuit 903 supplies to the polarization varying element 603, the driving waveform based on the waveform signal output from the waveform producing circuit 902.

The control circuit 901 outputs to the waveform producing circuit 904, a signal that indicates the driving waveform to the LCOS 610 and corresponding to the modulation information (the two-dimensional image data). The waveform producing circuit 904 produces the waveform signal of the voltage waveform based on the signal output from the control circuit 901, and outputs the produced waveform signal to the driving circuit 905. The driving circuit 905 supplies to the LCOS 610 the driving waveform based on the waveform signal output from the waveform producing circuit 904.

The amplitudes of the driving waveforms to be supplied by the control unit 622 to the polarization varying element 603 and the LCOS 610 may be adjusted by using, for example, the values of the signals output by the control circuit 901 to the waveform producing circuits 902 and 904, the electric power sources used by the waveform producing circuits 902 and 904, and the like.

The control circuit 901, the waveform producing circuits 902 and 904, and the driving circuits 903 and 905 may be realized by, for example, one or more microcomputer(s), custom integrated circuit(s) (IC(s)), or the like. The waveform producing circuit 902 may include an electric power source. The hardware configuration of the components of the control unit 622 is however not limited to the above and any one of various types of hardware configuration may be employed.

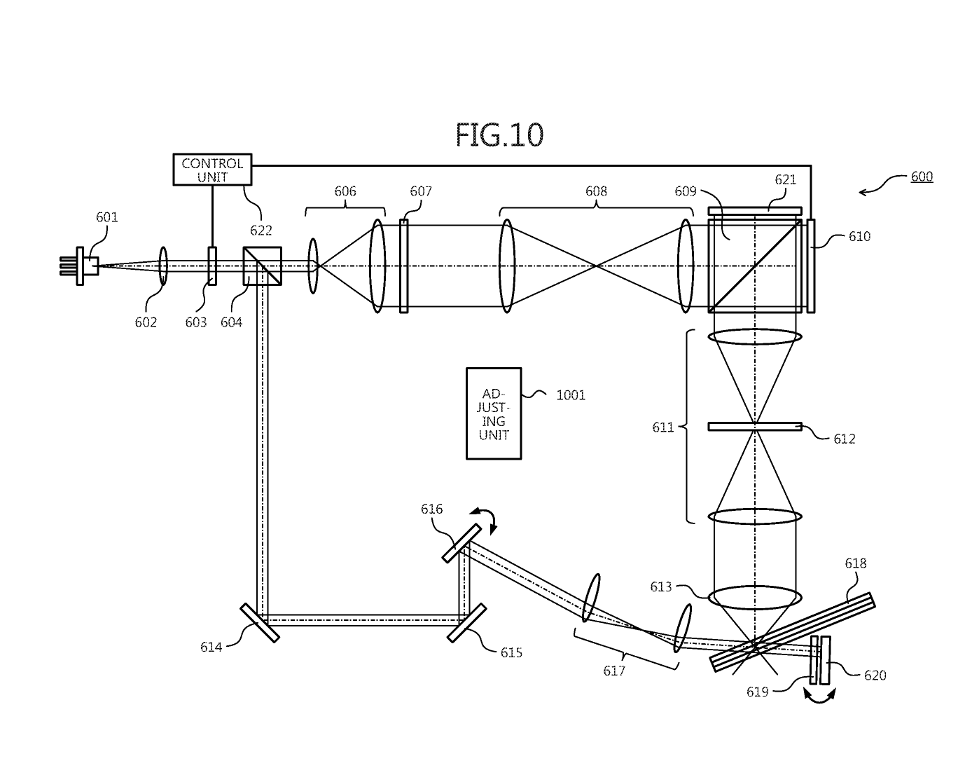

FIG. 10 is a diagram of a modification of the optical recording apparatus according to the embodiment. In FIG. 10, portions identical to the portions depicted in FIG. 6 are given the same reference numerals used in FIG. 6 and will not again be described. As depicted in FIG. 10, the optical recording apparatus 600 may include an adjusting unit 1001 in addition to the configuration depicted in FIG. 6.

The adjusting unit 1001 directly or indirectly adjusts the temperatures of the polarization varying element 603 and the LCOS 610. For example, the adjusting unit 1001 adjusts the temperature of the overall optical recording apparatus 600. Any one of various types of temperature adjusting device such as, for example, a Peltier device, a heater, an air blower, or a combination of some of these is usable as the adjusting unit 1001. The adjusting unit 1001 may be an adjusting unit that has a function of directly or indirectly measuring the temperatures of the polarization varying element 603 and the LCOS 610, and that executes the temperature adjustment such that the measured temperature becomes the target temperature.

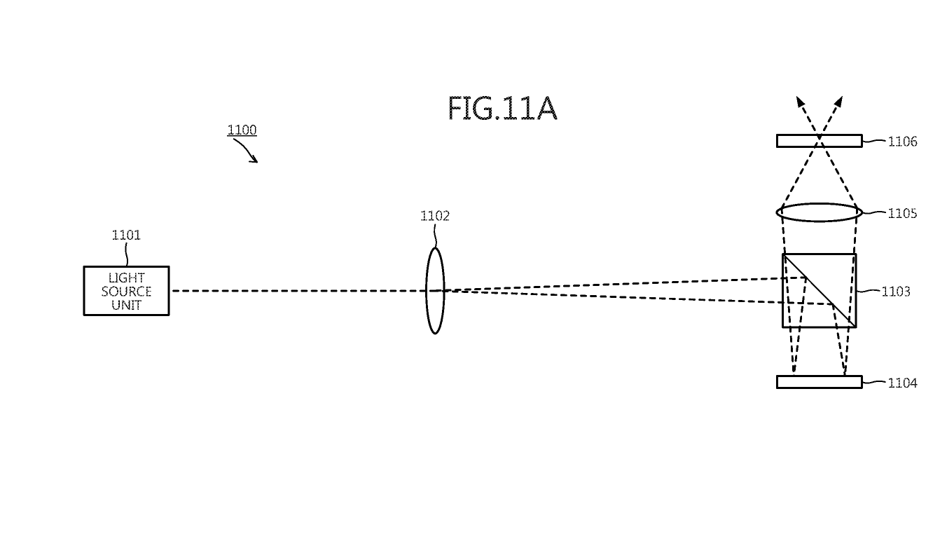

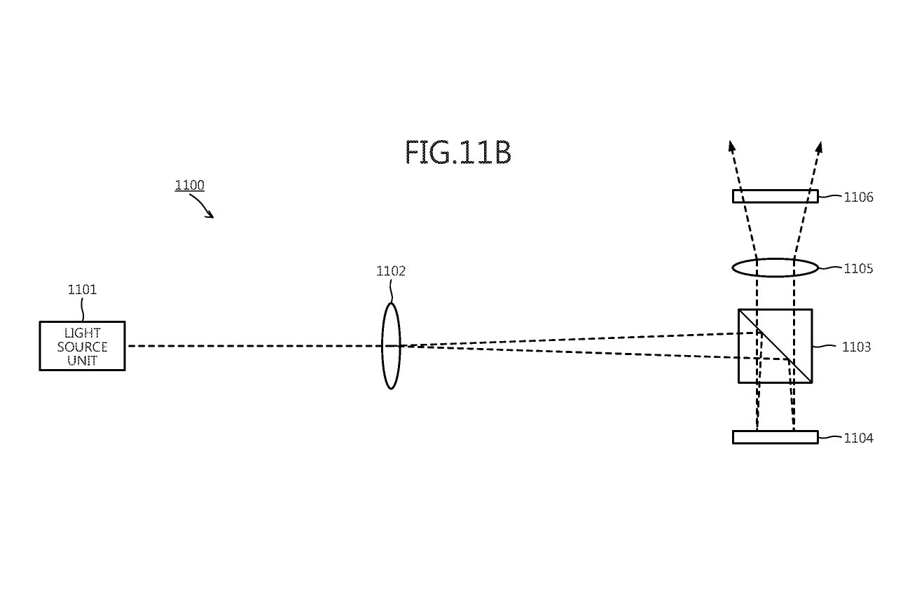

FIG. 11A is a diagram of an example of the configuration of a video image engine according to the embodiment. The video image engine 1100 depicted in FIG. 11A includes a light source unit 1101, lenses 1102 and 1105, a polarization beam splitter 1103, an LCOS 1104, and a liquid crystal shutter 1106.

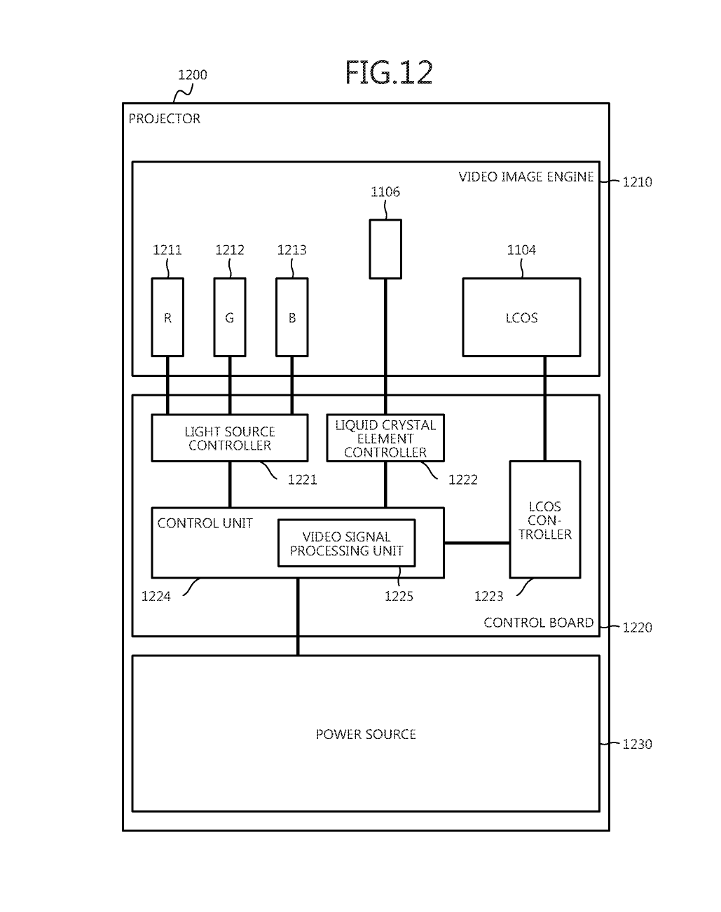

The optical device 100 depicted in FIG. 1 may be realized by, for example, the video image engine 1100. In this case, the liquid crystal shutter 110 depicted in FIG. 1 may be realized by, for example, the liquid crystal shutter 1106. The predetermined polarization optical element is, for example, eye glasses 1331 and 1332 described later. The LCOS 120 depicted in FIG. 1 may be realized by, for example, the LCOS 1104. The supplying unit 130 depicted in FIG. 1 may be realized by, for example, a control board 1220 (see FIG. 12) described later.

The lens 1102 outputs a laser light beam emitted from the light source unit 1101 to the polarization beam splitter 1103. The polarization beam splitter 1103 reflects the laser light beam output from the lens 1102 and outputs the laser light beam to the LCOS 1104. The polarization beam splitter 1103 outputs the laser light beam output from the LCOS 1104 to the lens 1105 corresponding to the polarization state.

The LCOS 1104 is a modulator that forms a video image by spatially modulating the laser light beam. The LCOS 1104 reflects the laser light beam output from the polarization beam splitter 1103 to the polarization beam splitter 1103. The LCOS 1104 controls the polarization state of the reflected light beam in each pixel corresponding to the voltage applied to the pixel of the face on which the laser light beam is reflected. The intensity of the laser light beam transmitted from the polarization beam splitter 1103 to the side of the lens 1105 can thereby be controlled for each pixel. For example, the reflective LCOS 800 depicted in FIGS. 8A and 8B is usable as the LCOS 1104.

The lens 1105 narrows the laser light beam output from the polarization beam splitter 1103 and outputs the narrowed laser light beam to the liquid crystal shutter 1106. The lens 1105 may have a configuration having plural lenses combined therein. The liquid crystal shutter 1106 controls the polarization state of the laser light beam output from the lens 1105 and outputs the laser light beam downstream thereof. The laser light beam output from the liquid crystal shutter 1106 is projected onto, for example, a screen. For example, the liquid crystal cell 700 depicted in FIG. 7 is usable as the liquid crystal shutter 1106.

FIG. 11B is a diagram of a modification of the example of the configuration of the video image engine. In FIG. 11B, configurations identical to those of FIG. 11A are given the same reference numerals used in FIG. 11A and will not again be described. For example, when an FLC is used as the liquid crystal shutter 1106, the light beam after passing through the polarization beam splitter 1103 does not need to be narrowed and, as depicted in FIG. 11B, the reflected light beam from the LCOS 1104 may therefore be projected without being narrowed.

FIG. 12 is a diagram of an example of the configuration of a projector to which the video image engine is applied. In FIG. 12, portions identical to the portions depicted in FIG. 11B are given the same reference numerals used in FIG. 11B and will not again be described. The projector 1200 depicted in FIG. 12 includes a video image engine 1210, the control board 1220, and an electric power source 1230.

For example, the video image engine 1100 depicted in FIG. 11A or 11B may be applied to the video image engine 1210. In this case, the video image engine 1210 includes a red light source 1211, a green light source 1212, a blue light source 1213, the LCOS 1104, and the liquid crystal shutter 1106. The red light source 1211, the green light source 1212, and the blue light source 1213 are configurations that correspond to the light source unit 1101 depicted in FIGS. 11A and 11B.

The control board 1220 includes a light source controller 1221, a liquid crystal element controller 1222, an LCOS controller 1223, and a control unit 1224. The light source controller 1221 controls the laser light beams emitted from the red light source 1211, the green light source 1212, and the blue light source 1213 by controlling the driving currents supplied to the red light source 1211, the green light source 1212, and the blue light source 1213 according to the control from the control unit 1224.

The liquid crystal element controller 1222 controls the polarization state of the laser light beams output from the projector 1200 by controlling voltages applied to the electrodes of the liquid crystal shutter 1106 according to the control from the control unit 1224.

The control unit 1224 includes a video signal processing unit 1225. The video signal processing unit 1225 executes video image processing based on the video signal input into the projector 1200. The control unit 1224 controls the light source controller 1221, the liquid crystal element controller 1222, and the LCOS controller 1223 at predetermined timings based on the video image processing by the video signal processing unit 1225.

The LCOS controller 1223 modulates the laser light beams by controlling the voltages applied to the electrodes of the LCOS 1104 according to the control from the control unit 1224, and controls the image and the video image of the laser light beams output from the projector 1200. The video image can thereby be displayed by projecting the laser light beams output from the projector 1200 onto the screen. The electric power source 1230 is the electric power source of the control board 1220. The electric power source 1230 may be a battery.

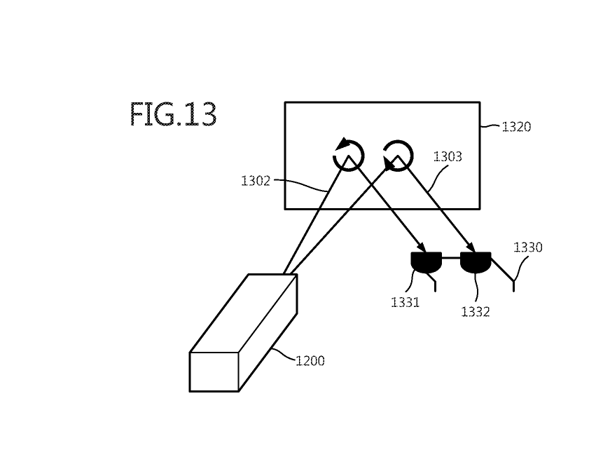

FIG. 13 is a diagram of an example of a utilization form of the projector. A projector 1200 depicted in FIG. 13 is, for example, the projector 1200 depicted in FIG. 12. The projector 1200 alternately emits a left-handed circular polarity laser light beam 1302 and a right-handed circular polarity laser light beam 1303 to the screen 1320 according to the control of the liquid crystal shutter 1106. The laser light beams 1302 and 1303 are each modulated to form a video image from a viewpoint different from that of each other according to the control of the LCOS 1104.

A pair of three-dimensional eye glasses 1330 includes the eye glass 1331 that transmits therethrough only the left-handed circular polarity laser light beam 1302, and the eye glass 1332 that transmits therethrough only the right-handed circular polarity laser light beam 1303. A person wearing the pair of three-dimensional eye glasses 1330 can thereby be caused to visually perceive a three-dimensional video image. Though the configuration to realize a three-dimensional video image by switching circular polarization has been described, for example, a configuration may be employed that realizes a three-dimensional video image by switching the linear polarization between those of different directions.

As described, the projector 1200 is the projector that applies signal light beams modulated by the LCOS 1104 to the eye glasses 1331 and 1332 (plural polarization filters) that each transmit therethrough a light beam in a polarization state different from that of each other. The liquid crystal shutter 1106 alternately switches the transmission state of the signal light beam applied to the eye glasses 1331 and 1332 by alternately switching the polarization state of the signal light beam applied to the eye glasses 1331 and 1332. A user may be caused to perceive a stereoscopic video image.

The contrasts of the LCOS 1104 and the liquid crystal shutter 1106 may be enhanced by applying the optical device 100 to the projector 1200, whereby a high contrast stereoscopic video image may be realized.

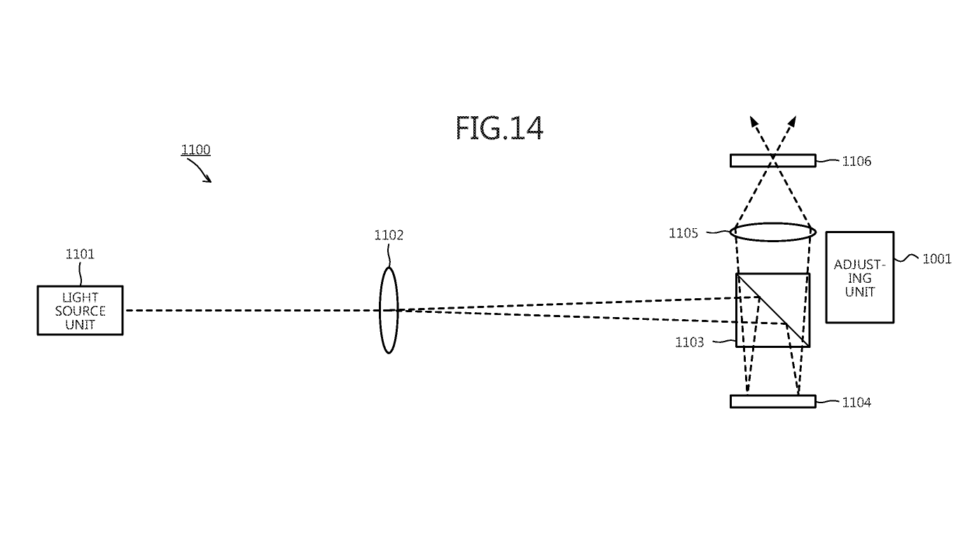

FIG. 14 is a diagram of a modification of the video image engine according to the embodiment. In FIG. 14, portions identical to the portions depicted in FIG. 11A are given the same reference numerals used in FIG. 11A and will not again be described. As depicted in FIG. 14, the video image engine 1100 may include the adjusting unit 1001 in addition to the configuration depicted in FIG. 11A. The adjusting unit 1001 is same as, for example, the adjusting unit 1001 depicted in FIG. 10.

The adjusting unit 1001 directly or indirectly adjusts the temperatures of the LCOS 1104 and the liquid crystal shutter 1106. For example, the adjusting unit 1001 adjusts the temperature of the overall video image engine 1100. The adjusting unit 1001 may be an adjusting unit that has a function of directly or indirectly measuring the temperatures of the LCOS 1104 and the liquid crystal shutter 1106 and that executes the temperature adjustment such that the measured temperature becomes the target temperature.

The configuration depicted in FIG. 14 may be a configuration to project the reflected light beam from the LCOS 1104 without narrowing the reflected light beam as depicted in FIG. 11B.

As described, according to the optical device 100, the contrasts of the liquid crystal shutter 110 and the LCOS 120 can each be set to be equal to or greater than 50% of the maximal contrast at the same temperature by adjusting the driving waveforms supplied to the liquid crystal shutter 110 and the LCOS 120. Improvement of the contrast of the liquid crystal shutter 110 can therefore be facilitated.

However, with the above conventional techniques, the characteristics required for the shutter and the spatial light modulator differs and therefore, the shutter and the spatial light modulator may each use therein a liquid crystal material that differs. In this case, the characteristics of the switching angle of the liquid crystal molecules with respect to temperature differs between the shutter and the spatial light modulator, and a problem arises that it is difficult to enhance the contrast of the optical device.

According the present invention, the contrasts of the liquid crystal shutter and the spatial light modulator each using the liquid crystal material different therebetween can thereby each be set to be equal to or greater than 50% of the maximal contrast at the same temperature by adjusting the amplitudes of the driving waveforms to be supplied to the liquid crystal shutter and the spatial light modulator.

According to an aspect of the present invention, an effect is achieved that improvement of the contrast may be facilitated.

As described, the optical device according to the present invention is useful for an optical device that includes plural liquid crystal cells and is especially suitable for an optical device that includes a liquid crystal shutter and an LCOS.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An optical device comprising:
a liquid crystal shutter using a first liquid crystal material, the liquid crystal shutter controlling application of a light beam to a predetermined point, corresponding to a driving waveform supplied to the liquid crystal shutter;
a spatial optical modulator using a second liquid crystal material whose contrast becomes a maximal contrast at a temperature different from that of the first liquid crystal material, the spatial optical modulator modulating the light beam corresponding to a driving waveform supplied to the spatial optical modulator; and
a supplying unit that supplies to the liquid crystal shutter and the spatial optical modulator, driving waveforms that are adjusted such that the contrasts of the liquid crystal shutter and the spatial optical modulator each become equal to or greater than 50% of the maximal contrast at a same temperature.

2. The optical device according to claim 1, further comprising
an adjusting unit that adjusts the temperatures of the first liquid crystal material and the second liquid crystal material to be close to the same temperature.

3. The optical device according to claim 1, wherein
each of the first liquid crystal material and the second liquid crystal material is a ferroelectric liquid crystal (FLC) or an anti-ferroelectric liquid crystal (AFLC).

4. The optical device according to claim 3, wherein
the first liquid crystal material and the second liquid crystal material are liquid crystal materials whose switching angle characteristics of liquid crystal molecules thereof differ from each other according to temperature when a same driving waveform is applied to the first liquid crystal material and the second liquid crystal material.

5. The optical device according to claim 1, wherein
the optical device is an optical recording apparatus that records information to an optical information recording medium by applying a signal light beam modulated by the spatial optical modulator to the optical information recording medium and that converts a reproduction light beam obtained by applying a reference light beam to the optical information recording medium into an electric signal using an imaging element, and wherein
the liquid crystal shutter controls the application of the signal light beam to the spatial optical modulator.

6. The optical device according to claim 1, wherein
the optical device is a projector that applies a signal light beam modulated by the spatial optical modulator to a plurality of polarization filters transmitting therethrough light beams having polarization states different from each other, and
the liquid crystal shutter switches a transmission state of the signal light beam in the plurality of polarization filters by alternately switching the polarization state of the signal light beam.
